(19) United States
(12) Patent Application Publication
(10) Pub. No.: US 2010/0036913 A1
(43) Pub. Date: Feb. 11, 2010

(54) NETWORK SETTING METHOD AND NETWORK SETTING APPARATUS

(75) Inventor: Yuji Imai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/473,046

(22) Filed: May 27, 2009

(30) Foreign Application Priority Data
Aug. 5, 2008 (JP) 2008-201433

(51) Int. Cl. G06F 15/16; G06F 15/177; G06F 9/455

(52) U.S. Cl. 709/205; 709/222; 718/1

(57) ABSTRACT

An administrative manager connected to a plurality of servers each including a virtual machine environment in which a host OS and a guest OS are operable as virtual OS, performs the following processes. Namely, when an operator issues an instruction to migrate the guest OS from a migration source server to a migration target server, a connection target server of the migration source server is specified, and also, connection information necessary for a virtual network connection between the connection target server and the migration target server is acquired. Then, before the guest OS is migrated, in the connection target server, transmission data to the migration objective guest OS is set to be looped back. Further, after the guest OS is migrated, the network setting is made on the migration target server and the connection target server so as to enable the mutual virtual network connection.

### CROSS-REFERENCE TO RELATED APPLICATION

This application is based upon and claims the benefit of priority of the prior Japanese Patent Application No. 2008-201433, filed on Aug. 5, 2008, the entire contents of which are incorporated herein by reference.

### FIELD

The embodiment discusses herein is directed to a technology for performing automatic network setting on servers each of which is applied with a virtualization technology.

### BACKGROUND

In recent years, demands for implementing outsourcing of information processing systems of service enterprises and the like are increased, and the market thereof is expanded. A data center collectively undertaking such outsourcing includes a server node pool configured by a plurality of servers. Then, service programs for processing customers' services of which outsourcings are consigned are discretely allocated to the plurality of servers configuring the server node pool, according to functions thereof, and also, these servers are physically network-connected.

In the server node pool described above, in order to separately administrate the services of the plurality of customers, a technology for setting a virtual machine environment in each server is generalized. To be specific, in each server, as a virtual operating system (hereunder, “operating system” is to be referred to as an OS (operating system), i.e., virtual OS, and the same rule will be applied to other operating systems), a host OS being a basis in the virtual machine environment is operated, and also, a guest OS as an environment for executing the service program is operated. Thus, even in the case where the service programs for the plurality of customers are processed on the same server, it is possible to avoid that data processed by the service programs for the customers are mixed among the customers. Further, in such a server node pool, since the physical network among the servers is shared by the plurality of customers, in order to avoid information leakage among the customers, unauthorized access and the like, a method described below is further adopted. Namely, the physical network among the servers is sectioned in L2 (Layer-2) sections using a VLAN (Virtual Local Area Network) technology or is sectioned using a VPN (Virtual Private Network) technology to thereby virtually divide the physical network, so that a virtual intranet is set up for each customer (refer to Japanese National Publication of International Patent Application No. 2004-503011).

Here, during consecutive operations of such a system, there may be caused necessity of alteration or relocation of system configuration. In such a case, a guest OS that has operated in a certain server is shifted (migrated) to another server. At this time, it is necessary to establish a virtual network connection between connection target servers which have been virtually network-connected to a migration source server, and a new migration target server. Therefore, it is necessary to perform again virtual network setting on both of the migration target server and the connection target servers.

However, since a virtual network configuration of the server node pool is complicated, the virtual network setting work for the migration target server and all of the connection target servers requires a large burden and also takes a long time. Further, it is firstly difficult to grasp what servers the migration source server has been virtually network connected to, and also, mistakes such as setting failure or the like are susceptible to arise. Furthermore, during the migration of the guest OS, data transmitted from the connection target servers to the migration objective guest OS may not be normally processed and returned as errors to the connection target servers being transmission sources. Therefore, at every migration of the guest OS, processing of customer's service is interrupted to thereby cause troubles in the customer's service.

### SUMMARY

According to an aspect of the embodiment, a computer connected to a plurality of servers each including a virtual machine environment in which a host OS and a guest OS are operable as virtual OS, executes the following processes. Namely, when an operator issues an instruction to migrate the guest OS from a migration source server to a migration target server, a connection target server of the migration source server is specified, and also, connection information necessary for establishing a virtual network connection between the connection target server and the migration target server is acquired. Then, before the guest OS is migrated, in the connection target server, transmission data transmitted to the migration objective guest OS is set to be looped back. Further, after the guest OS is migrated, the virtual network connection is set to the migration target server, so that the transmission data for the guest OS that operates in the connection target server is transmitted from the migrated guest OS. On the other hand, in place of loopback setting, the virtual network connection is set to the connection target server, so that the transmission data is transmitted to the migration objective guest OS migrated to the migration target server.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is an entire configuration view of a system providing a network setting mechanism;

FIG. 2 is an explanatory view of a server configuration and a structure of data transfer between two servers;

FIG. 3A is an explanatory view of a setting table of a routing section;

FIG. 3B is an explanatory view of a setting table of a tunneling section;

FIG. 4 is a configuration view of an administrative manager;

FIG. 5 is an explanatory view of a service administration table;

FIG. 6 is an explanatory view of a physical IP address table;

FIG. 7 is an explanatory view of an interface administration table;

FIG. 8 is a flowchart of a network setting process by the administrative manager;

FIG. 9 is an explanatory view of a server configuration before processing network setting, in a specific example of the network setting process;

FIG. 10A is an explanatory view of the service administration table before processing the network setting, in the specific example of the network setting process;

FIG. 10B is an explanatory view of the physical IP address table before processing the network setting, in the specific example of the network setting process;

FIG. 10C is an explanatory view of the interface administration table before processing the network setting, in the specific example of the network setting process;

FIG. 11A is an explanatory view of the setting table of the routing section in the server α before processing the network setting, in the specific example of the network setting process;

FIG. 11B is an explanatory view of the setting table of the tunneling section in the server α before processing the network setting, in the specific example of the network setting process;

FIG. 12A is an explanatory view of the setting table of the routing section in the server γ before processing the network setting, in the specific example of the network setting process;

FIG. 12B is an explanatory view of the setting table of the tunneling section in the server γ before processing the network setting, in the specific example of the network setting process;

FIG. 13A is an explanatory view of the setting table of the routing section in the server γ in a state where loopback setting is performed, in the specific example of the network setting process;

FIG. 13B is an explanatory view of the interface administration table in the state where the loopback setting is performed, in the specific example of the network setting process;

FIG. 14A is an explanatory view of the setting table of the tunneling section in the server β after processing the network setting, in the specific example of the network setting process;

FIG. 14B is an explanatory view of the setting table of the tunneling section in the server γ after processing the network setting, in the specific example of the network setting process;

FIG. 15A is an explanatory view of the setting table of the routing section in the server β after processing the network setting, in the specific example of the network setting process;

FIG. 15B is an explanatory view of the setting table of the routing section in the server γ after processing the network setting, in the specific example of the network setting process;

FIG. 16A is an explanatory view of the service administration table after processing the network setting, in the specific example of the network setting process;

FIG. 16B is an explanatory view of the interface administration table after processing the network setting, in the specific example of the network setting process; and

FIG. 17 is an explanatory view of the server configuration after processing the network setting, in the specific example of the network setting process.

### DESCRIPTION OF EMBODIMENT

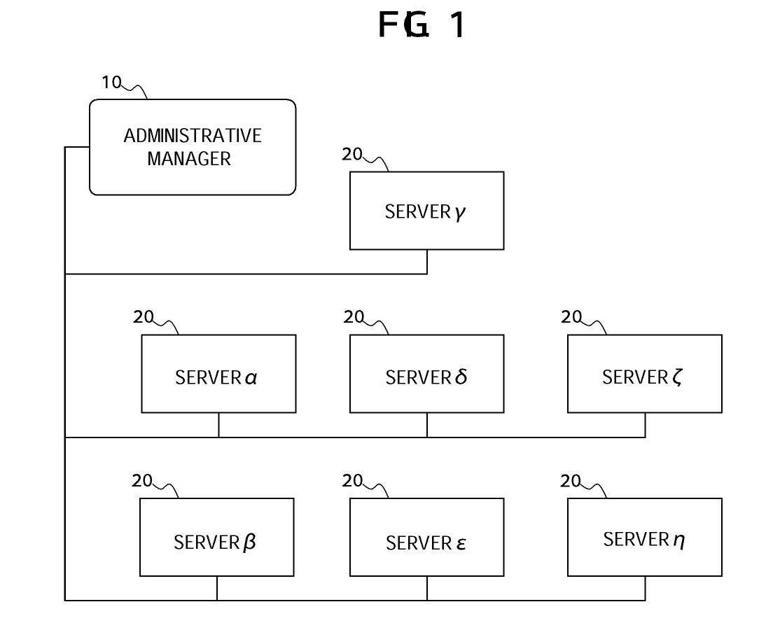

FIG. 1 illustrates an entire configuration of a system providing a network setting mechanism. This system is the one set up in a server node pool installed in a data center that collectively administrates plural customers' services, and in this system, an administrative manager 10 and a plurality of servers 20 processing the customers' services are network-connected. The administrative manager 10 administrates the entirety of servers 20 in lump, and also, performs various types of setting on the servers 20 by remote controls. Further, the administrative manager 10 and the servers 20 are all configured by computers each provided with at least a CPU (Central Processing Unit) and a memory.

In the plurality of servers 20 configuring the server node pool, service programs for processing the services of plural customers who consigned outsourcing to the data center are arranged. Further, each server 20 is provided with a virtual machine environment capable of operating a virtual OS. Furthermore, the servers 20 establish the VPN connection to one another in P2P (Peer to Peer) using a virtual (private) network (VPN: Virtual Private Network), and the system is divided for each customer to thereby set up a virtual intranet. Incidentally, the above virtual intranet divided for each customer is connected to own system of individual customer.

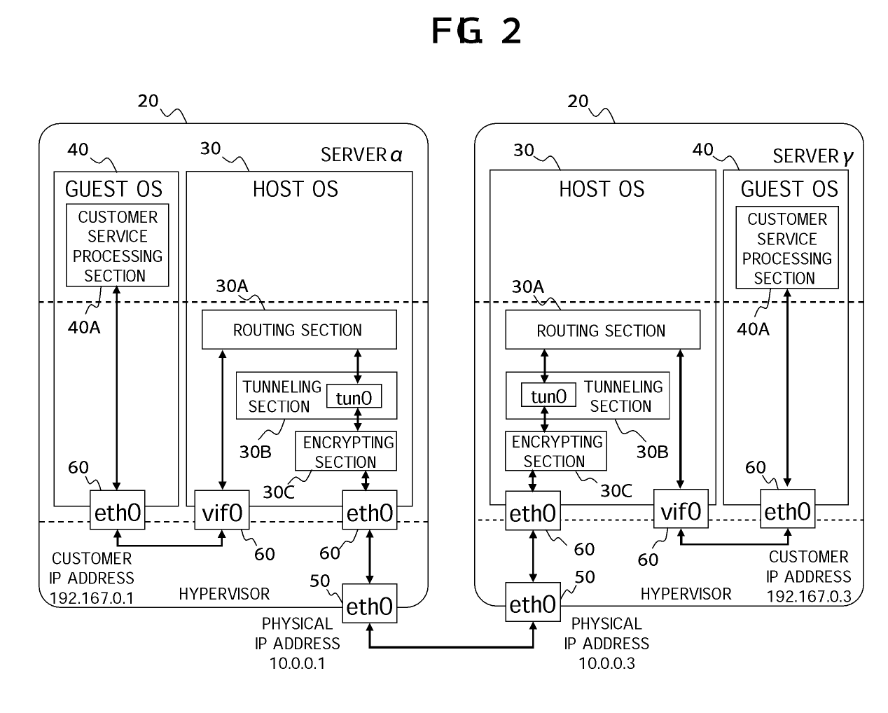

Next, referring FIG. 2, there will be described a configuration of each server 20 provided with the virtual machine environment and a structure of the VPN connection among the servers 20.

In the server 20, the virtual machine environment is set up, and a host OS 30 and a guest OS 40 operate as virtual OS. The host OS 30 and the guest OS 40 are controlled on a hypervisor functioning as an OS control program.

Further, the server 20 is provided with a physical NIC (Network Interface Card) 50 for performing communications with other computers. Then, the server 20 is allocated with a physical IP address which is uniquely identified in the server node pool. Furthermore, each of the host OS 30 and the guest OS 40 operating in the server 20 is provided with virtual NIC 60, and communications between the host OS 30 and the guest OS 40 in the same server are performed using this virtual NIC 60. Then, the guest OS 40 operating in the server is allocated with a customer IP address as a virtual IP address which is a unique address different from the physical IP address.

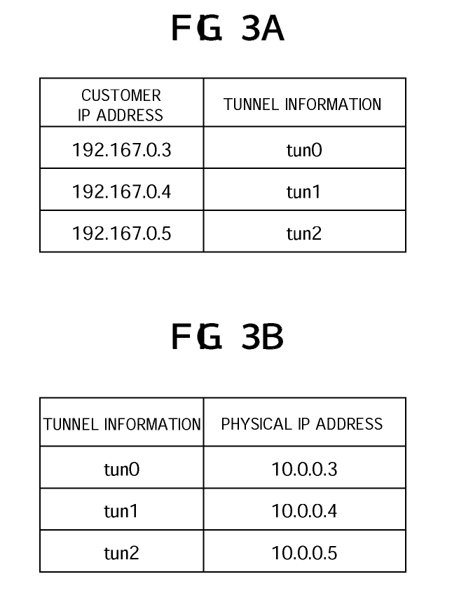

Further, the host OS 30 includes an element described below. Namely, the host OS 30 includes a routing section 30A that, when transmission data is received from the guest OS 40, specifies tunnel information for transmitting the transmission data via the VPN connection. As illustrated in FIG. 3A, the routing section 30A is provided with a routing setting table in which the customer IP addresses of the transmission targets and the tunnel information to be used for the VPN connection to the transmission target are set. Then, the routing section 30A refers to the routing setting table and specifies a tunnel to be used for VPN communications based on the customer IP address attached to the transmission data. Further, the host OS 30 includes a tunneling section 30B that attaches the physical IP address of the transmission target to the transmission data and also encapsulates the transmission data to thereby perform tunneling. As illustrated in FIG. 3B, the tunneling section 30B is provided with a tunneling setting table in which the tunnel information and the physical IP addresses being the transmission targets of the tunnels are set. Then, the tunneling section 30B specifies the physical IP address of the transmission target from the tunnel information, based on the tunneling setting table. Further, the host OS 30 includes an encrypting section 30C that encrypts the transmission data. Incidentally, when data is received from the other server 20, in the host OS 30, the received data is decrypted in the encrypting section 30C and encapsulation thereof is released in the tunneling section 30B, and also, the received data is transmitted to the guest OS 40 of the customer IP address attached to the received data.

On the other hand, the guest OS 40 includes a customer's service processing section 40A that executes the service program. Incidentally, in an example of FIG. 2, only one guest OS operates, but a plurality of guests OS can operate.

Here, referring the example of FIG. 2, there will be described a process of data transmission from the service program executed in the customer's service processing section 40A in the guest OS 40 of the server α to the service program executed in the customer's service processing section 40A in the guest OS 40 of a server γ. Firstly, the data is transmitted from the service program executed in the customer's service processing section 40A of the server α to the customer IP address (192.167.0.3) of the guest OS 40 of the server γ, which is the transmission target. This data is transmitted to the host OS 30 via the virtual NIC 60 (eth0) of the guest OS 40 and the virtual NIC 60 (vif0) of the host OS 30. Then, in the host OS 30, the routing setting table is referred to in the routing section 30A, to thereby acquire the tunnel information corresponding to the customer IP address of the transmission target. Further, in the host OS 30, the tunneling setting table is referred to in the tunneling section 30B, to thereby acquire the physical IP address (10.0.0.3) of the transmission target server corresponding to the tunnel information. Then, this physical IP address is attached to the transmission data, and thereafter, the transmission data is encapsulated and tunneled. Further, in the encrypting section 30C, the encapsulated transmission data is further encrypted by applying IPsec or the like. As a result, it becomes possible to establish the VPN connection to the server γ. Then, the transmission data is transmitted from the virtual NIC 60 (eth0) of the host OS 30 to the server γ via the physical NIC 50 (eth0) of the server α. On the other hand, in the host OS 30 of the server γ that received the transmission data, the reception data is transmitted to the guest OS 40 being the transmission target in which the service program is executed, based on the customer IP address attached to the reception data.

By adopting the configuration described above, in the case where the data transmission and reception is performed between the own server 20 and the other server 20 in the service program, in the guest OS 40, only the customer IP address of the transmission target may be set to the transmission data, and the setting of the physical IP address and the VPN connection is performed by the host OS 30. Therefore, when the customer accesses the server to execute the service program and communicate with the other server, it becomes possible to perform such communications without the necessity of directly controlling the host OS 30. Accordingly, it becomes possible to perform the communications with the other server without providing a control authorization of the host OS 30 to the customer, and consequently, it is possible to prevent troubles, such as erroneous alteration of the environment setting of the host OS 30 by the customer.

Next, there will be described the administrative manager 10 that administrates the entirety of servers 20 described above.

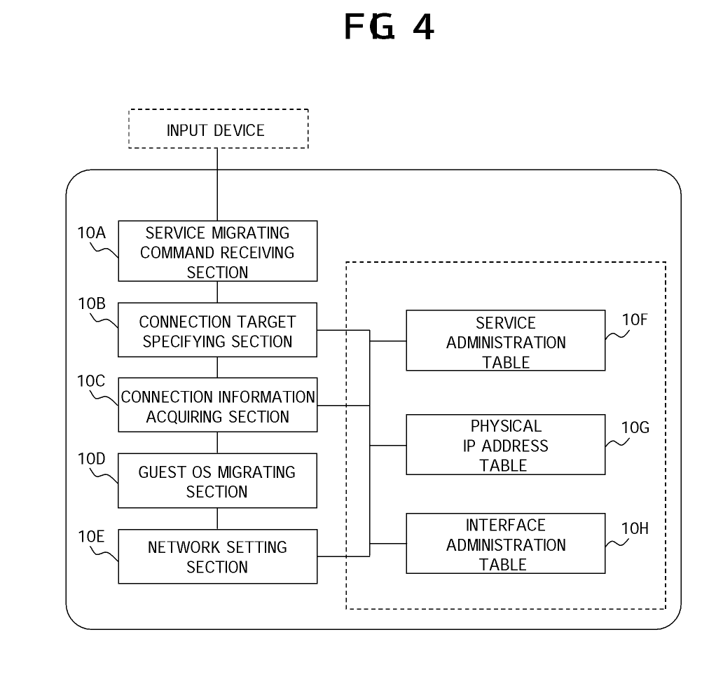

FIG. 4 is a configuration view of the administrative manager 10. The administrative manager 10 includes: a service migrating command receiving section 10A; a connection target specifying section 10B; a connection information acquiring section 10C; a guest OS migrating section 10D; a network setting section 10E; a service administration table 10F; a physical IP address table 10G; and an interface administration table 10H.

The service migrating command receiving section (unit) 10A is connected to an input device which can be operated by an operator. Then, the service migrating command receiving section 10A receives a service migrating command to migrate the guest OS 40 operating in the server 20 to the other server 20, which is input by the operator. In this service migrating command, the guest OS being a migration objective and a migration source server in which the migration source guest OS operates, and also, a migration target server being migration target of the migration objective guest OS, are designated.

The connection target specifying section 10B specifies a connection target server which establishes the VPN connection to the migration source server.

The connection information acquiring section 10C acquires connection information necessary for establishing the VPN connection between the connection target server and the migration target server.

The guest OS migrating section 10D is network-connected to each of the servers 20, and migrates the migration objective guest OS from the migration source server to the migration target server. At this point, the service program which has been executed on the guest OS in the migration source server becomes executable on the guest OS migrated to the migration target server.

The network setting section 10E is network connected to each of the servers 20, and makes VPN setting of the host OS 30 in the connection target server to be in a loopback state, before the guest OS is migrated. On the other hand, the network setting section 10E sets the connection information to the host OS 30 of the connection target server and the host OS 30 of the migration target server, after the guest OS is migrated.

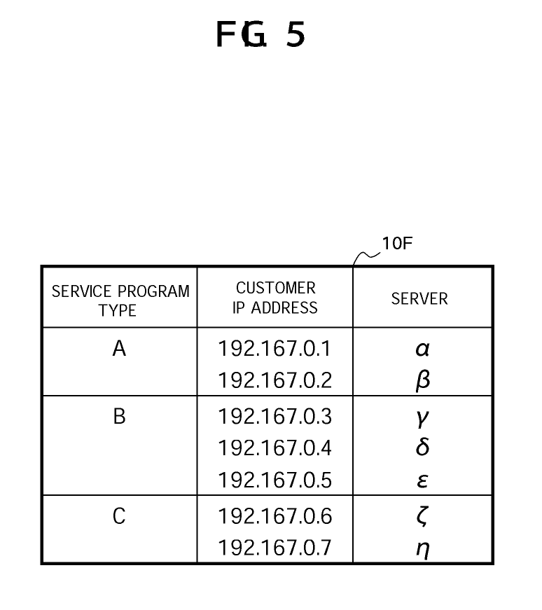

The service administration table 10F indicates, for each of service program types based on functions of the service programs, the servers 20 in which the service programs of respective service program types are executed. As illustrated in FIG. 5, in the service administration table 10F, the service program types, the customer IP addresses of the guests OS 40 executing the service programs of the service program types, and the server names are registered.

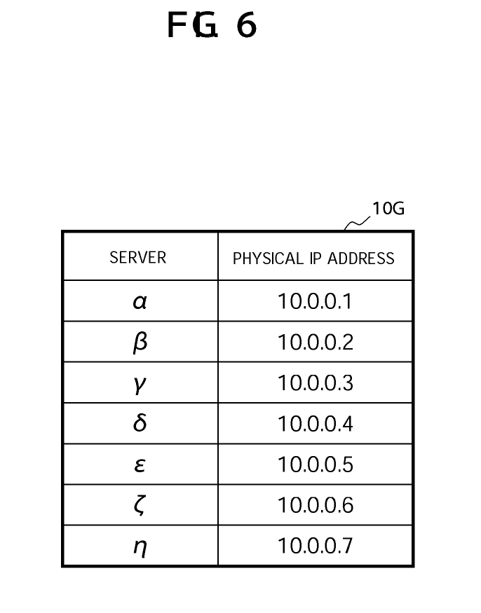

The physical IP address table 10G indicates the physical IP addresses of the servers 20, and, as illustrated in FIG. 6, in the physical IP address table 10G, the server names and the physical IP addresses of the servers are registered.

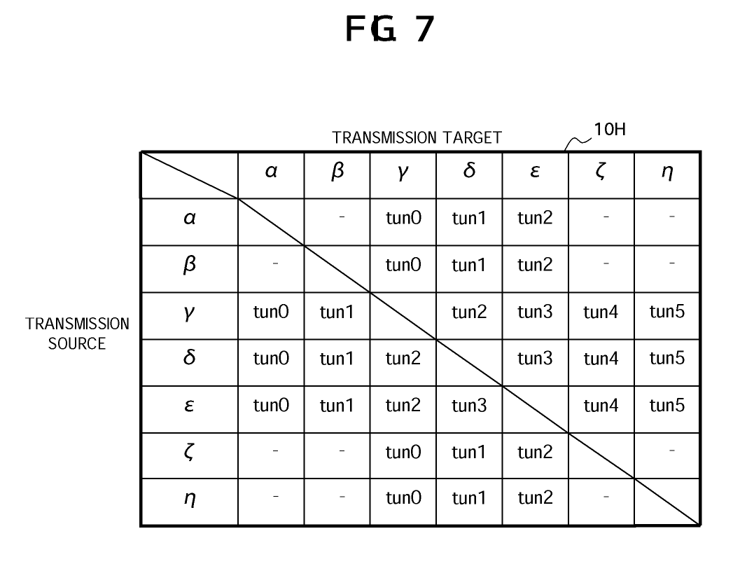

The interface administration table 10H indicates the tunnels to be used for the VPN connection among the servers 20, and, as illustrated in FIG. 7, in the interface administration table 10H, the transmission source servers and the transmission target servers, and also, the tunnel information are registered.

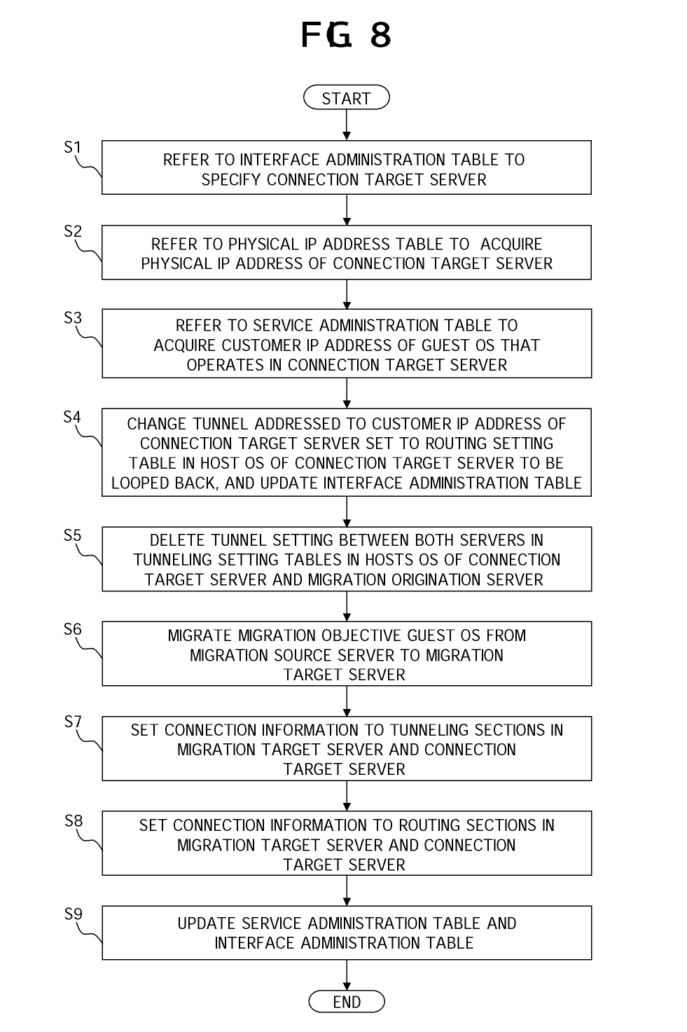

FIG. 8 illustrates a network setting process by the service starting command receiving section 10A, connection target specifying section 10B, connection information acquiring section 10C, guest OS migrating section 10D and network setting section 10E of the administrative manager 10. This process is executed when the operator issues the service migration command which designates the migration objective guest OS and the migration source server in which the migration objective guest OS operates, and the migration target server being migration target of the migration objective guest OS. Incidentally, the migration objective guest OS is designated by the customer IP address thereof. Further, the migration source server and the migration target server are designated, so that the physical IP addresses of the migration source server and the migration target server are acquired based on the physical IP address table 10G.

In step 1 (to be abbreviated as S1 in FIG. 8, and the same rule will be applied to subsequent steps), the interface administration table 10H is referred to. Then, from records in which the transmission source servers are coincident with the migration source servers, the transmission target server registered with the tunnel information is specified as the connection target server which is connected to the migration source server. Further, the tunnel information of the connection target server is acquired.

In step 2, referring to the physical IP address table 10G, the physical IP address of the connection target server is acquired.

In step 3, referring to the service administration table 10F, the customer IP address of the guest OS 40 of the connection target server is acquired.

In step 4, the tunnel addressed to the customer IP address of the migration objective guest OS, which is set to the routing setting table in the host OS of the connection target server, is changed to loopback (lo). Similarly, the tunnel information which is set in the interface administration table 10H, in which the connection target server is set as the transmission source server, and also, the migration source server is set as the transmission target server, is updated to be in the loopback state.

In step 5, the tunnel settings between the host OS in the connection target server and that in the migration source server, in the tunneling setting tables, are deleted. Similarly, the tunnel information which is set in the interface administration table 10H, in which the migration source server is set as the transmission source server, is deleted.

In step 6, the migration objective guest OS is migrated from the migration source server to the migration target server. Incidentally, at this point, the customer IP address of the migration objective guest OS is maintained as it is.

In step 7, in the tunneling section 30B of the migration target server, a new tunnel to be used for establishing the VPN connection to the connection target server is set. Namely, the tunnel to be used for establishing the VPN connection to the connection target server is determined, and the tunnel information of the new tunnel and the physical IP address of the connection target server are set to the tunneling setting table in the tunneling section 30B of the migration target server. Further, similarly to the above, a tunnel to be used for the VPN connection from the connection target server to the migration target server is determined, and the tunnel information of the set tunnel and the physical IP address of the migration target server are set to the tunneling setting table in the tunneling section 30B of the connection target server.

In step 8, the customer IP address of the connection target server and the tunnel information to be used for the VPN connection to the connection target server are set to the routing setting table in the routing section 30A of the migration target server. Further, the loopback setting of the tunnel information corresponding to the customer IP address of the migrated guest OS, in the routing setting table in the routing section 30A of the connection target server, is cancelled, and alternatively, the tunnel information to be used for the VPN connection to the migration target server is set.

In step 9, information of the guest OS of the migration target server is registered in the service administration table 10F and the interface administration table 10H.

Incidentally, when a plurality of connection target servers is determined in step 1, the above steps 2 to 9 are executed for the plurality of connection target servers.

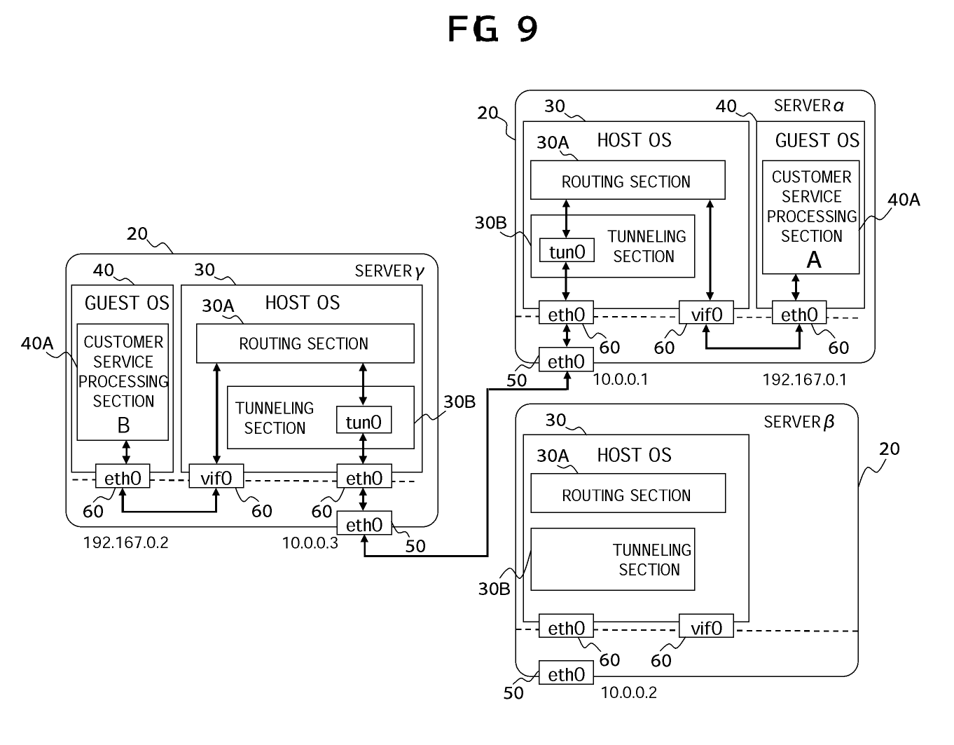

Here, there will be described the network setting process executed by the administrative manager 10 by indicating a specific example. An example of server configuration as illustrated in FIG. 9 is used herein. In this example, the guest OS executing the service program of service program type A operates in the server α and the guest OS executing the service program of service program type B operates in the server γ. Then, it is assumed that the service migrating command to migrate the guest OS in the server α to the server β is issued. Incidentally, in FIG. 9, the illustration of physical network connection between the administrative manger 10 and each server, and the illustration of a part of the configuration of each server, are omitted for convenience. Further, an arrow in a solid line between the servers indicates that the VPN connection is established.

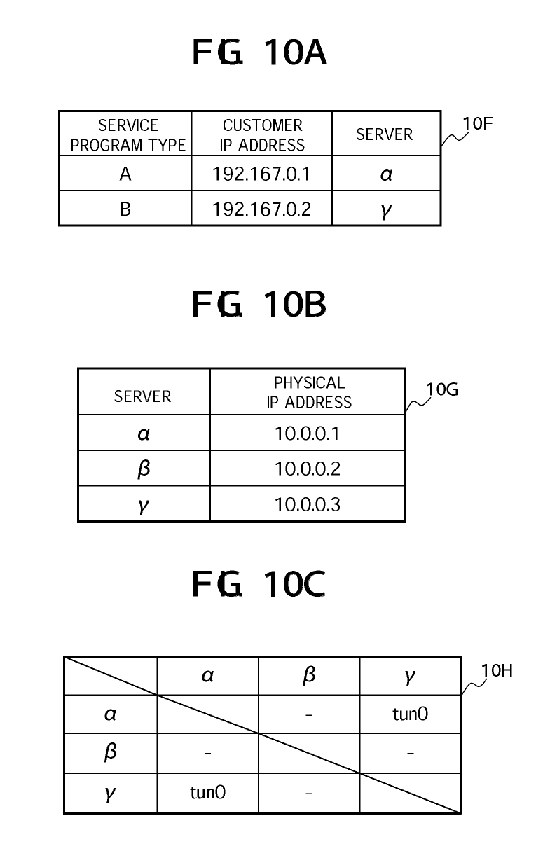

Further, in this example, the service administration table 10F, physical IP address table 10G and interface administration table 10H of the administrative manager 10 are set as illustrated in FIG. 10A, FIG. 10B and FIG. 10C, respectively.

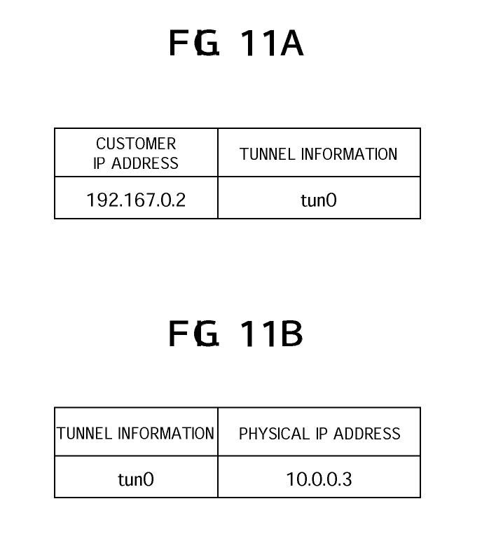

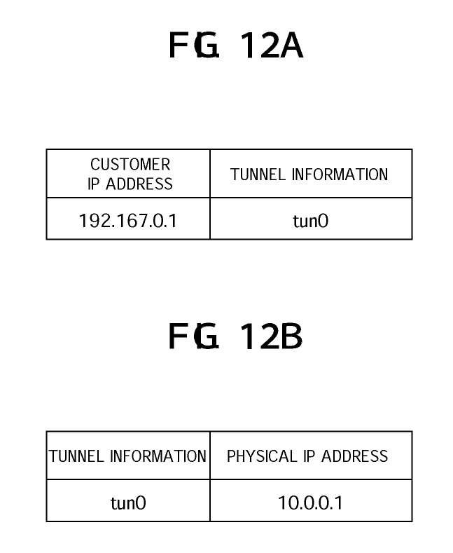

Furthermore, in this example, the settings as illustrated in FIG. 11A and FIG. 11B are provided in the routing setting table of the routing section 30A and the tunneling setting table of the tunneling section 30B in the server α, respectively. Still further, the settings as illustrated in FIG. 12A and FIG. 12B are respectively provided in the routing setting table of the routing section 30A and the tunneling setting table of the tunneling section 30B in the server γ.

Then, when the service migrating command is received in the service migrating command receiving section 10A, the connection target specifying section 10B refers to the interface administration table 10H illustrated in FIG. 10C. Then, the connection target specifying section 10B specifies the transmission target server in which the tunnel information is registered, that is, the server γ, as the connection target server being connected to the server α, from the records each in which the transmission source server is coincident with the server α being the migration source server. Further, the connection target specifying section 10B acquires the tunnel information (tun0) of the server γ (step 1). Furthermore, the connection information acquiring section 10C refers to the physical IP address table 10G, to acquire the physical IP address (10.0.0.3) of the server γ (step 2). Still further, the connection information acquiring section 10C refers to the service administration table 10F, to acquire the customer IP address (192.167.0.2) of the guest OS 40 in the server γ (step 3).

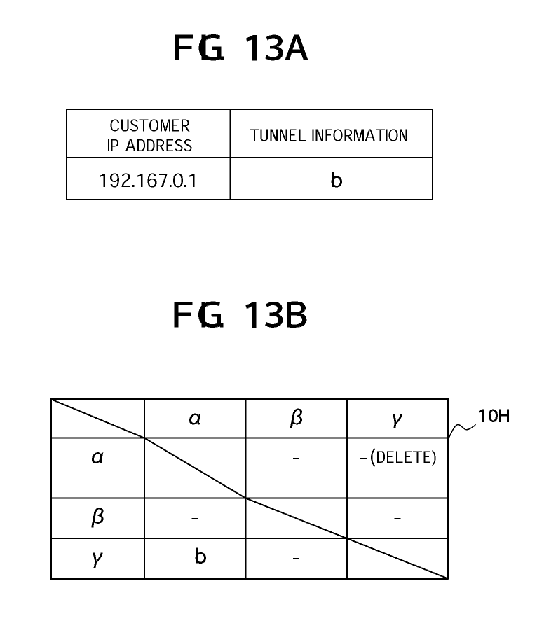

Here, the network setting section 10E changes the tunnel (tun0) addressed to the migration objective guest OS, that is, to the customer IP address of the guest OS in the server α, which is set to the routing setting table in the host OS of the server γ as illustrated in FIG. 12A, to “lo” indicating loopback as illustrated in FIG. 13A. Also, as illustrated in FIG. 13B, the network setting section 10E sets “lo” to the tunnel information which is set to the interface administration table 10H, in which the server γ is set as the transmission source server and the server α is set as the transmission target server, to update the tunnel information (step 4). Further, the network setting section 10E deletes the tunnel information between the server α and server γ, which is set to the tunneling setting tables in the hosts OS of the server α and server γ, and also, deletes the tunnel information which is set to the interface administration table 10H, in which the server α is set as the transmission source server, as illustrated in FIG. 13B (step 5). Then, the guest OS migrating section 10D migrates the migration objective guest OS from the server α to the server γ (step 6).

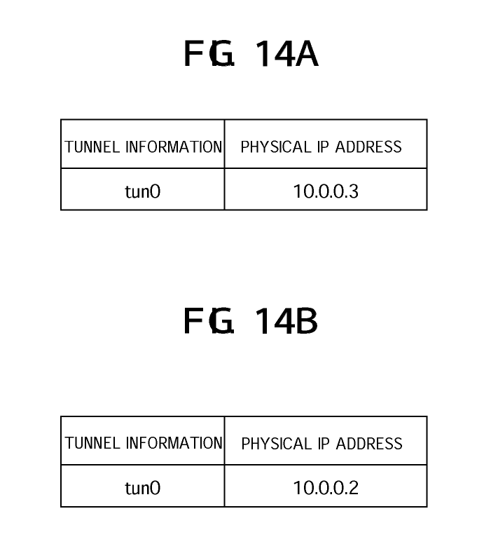

Further, as illustrated in FIG. 14A, the network setting section 10E set the new tunnel (tun0) with designating the physical IP address (10.0.0.3) of the server γ to the tunneling setting table in the tunneling section 30B of the server β, for the VPN connection from the server β to the server γ. On the other hand, as illustrated in FIG. 14B, the network setting section 10E set the new tunnel (tun0) with designating the physical IP address (10.0.0.2) of the server β to the tunneling section table in the tunneling section 30B of the server γ, for the VPN connection from the server γ to the server β (step 7).

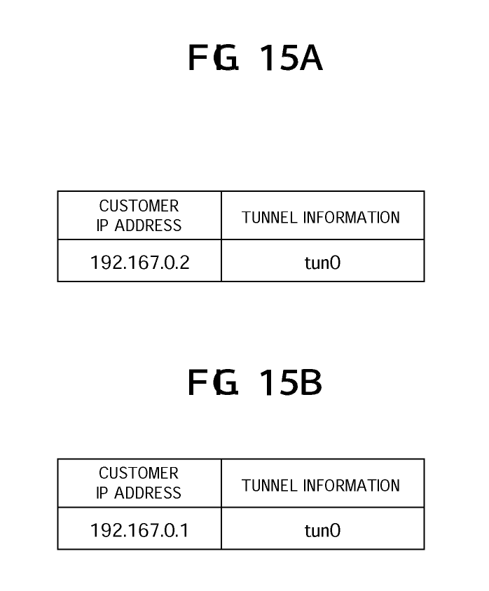

Further, as illustrated in FIG. 15A, the network setting section 10E sets the customer IP address (192.167.0.2) of the server γ and the tunnel information (tun0) thereof to the routing setting table in the routing section 30A of the server β. Furthermore, as illustrated in FIG. 15B, the network setting section 10E cancels loopback of the tunnel information of the customer IP address (192.167.0.1) of the server β, which is set to the routing setting table in the routing section 30A of the server γ, to set the new tunnel information (tun0) (step 8). Incidentally, the customer IP address of the migration objective guest OS in the setting of the server γ illustrated in FIG. 15B is same as that of the guest OS before migration as illustrated in FIG. 12A and FIG. 13A. This is because the customer IP address of the migration objective guest OS before migration is maintained even after the guest OS is migrated to the other server.

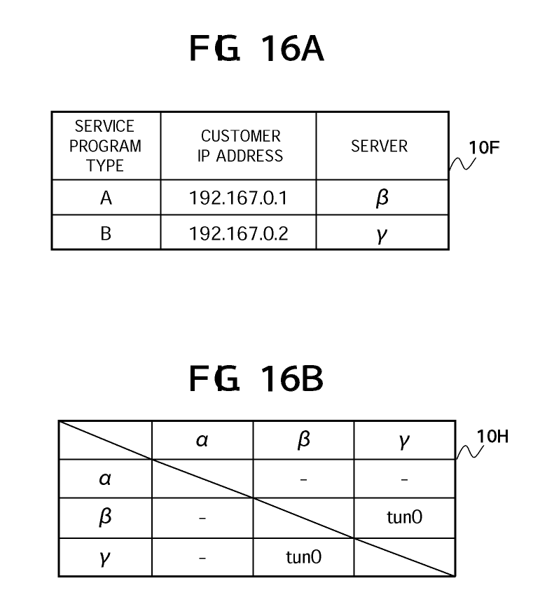

Further, as illustrated in FIG. 16A and FIG. 16B, the network setting section 10E registers the information of the guest OS in the migration target server to the service administration table 10F and the interface administration table 10H (step 9).

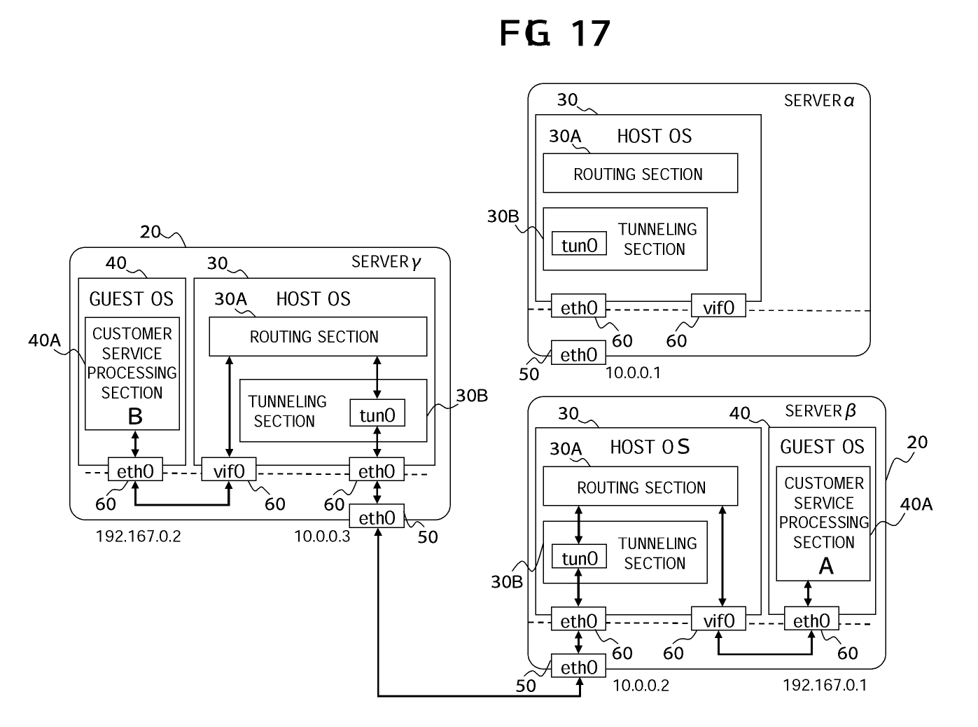

Then, by the above process, the guest OS is migrated from the server α to the server β, and also, the VPN connection is established between the server γ and the server β, as illustrated in from FIG. 9 which indicates the configuration after processing to FIG. 17 which indicates the configuration before processing.

According to the network setting process described above, by referring to the interface administration table 10H in the administrative manager 10, the connection target server which has been connected to the migration source server in which the migration objective guest OS operates, is specified. Further, by referring to the service administration table 10F and the physical IP address table 10G, the information necessary for the VPN connection from the migration target server to the connection target server, that is, the customer IP address of the guest OS which operates in the connection target server and the physical IP address of the connection target server, is acquired. Then, after the guest OS is migrated from the migration source server to the migration target server, using the connection information thereof, the customer IP address of the migration objective guest OS and the physical IP address of the migration target server, the VPN connection is set so as to enable the mutual VPN connection between both of the host OS of the migration target server and the host OS of the connection target server. Thus, the VPN connection between the migration target server and the connection target server is automatically set, so that time and burden necessary for the setting can be considerably decreased. Further, mistakes during the setting work can be prevented.

Further, in the process described above, before the guest OS is migrated, the setting of the VPN connection from the connection target server which has been connected to the migration source server in which the migration objective guest OS operates, to the migration source server, is changed to loopback. Then, the guest OS is migrated, and thereafter, the VPN connection is set between both of the host OS of the migration target server and the host OS of the connection target server. Therefore, the data transmitted from the guest OS of the connection target server to the migration objective guest OS during the migration of the guest OS, is not returned as errors to the connection target server being the transmission source. Accordingly, although the service program executed in the guest OS of the connection target server being the data transmission source may transmits data again, the service program processing itself is not interrupted immediately as errors. Consequently, the service program processing is not interrupted during the migration of the guest OS, and therefore, it becomes possible to perform the migration work without interfering with the customer's service processing.

All examples and conditional language recited herein are intended for pedagogical purposes to aid the reader in understanding the invention and the concepts contributed by the inventor for furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer readable recording medium storing a network setting program causing a computer, which is connected to a plurality of servers each including a virtual machine environment in which a host operating system that directly performs communications with another server using a virtual network and a guest operating system that is started up to execute a service program for processing a customer's service and performs communications with said another server only via the host operating system, are operable as virtual operating systems, to execute a process comprising:
when a first server of the plurality of servers is designated to be a migration source server and a second server is designated to be a migration target server, and when an operator issues an instruction to migrate a guest operating system that operates in the migration source server to the migration target server, referring to a table in which connection target servers being virtual network connection targets of the respective servers are set, to specify the connection target server of the migration source server;
acquiring connection information necessary for establishing a virtual network connection between the specified connection target server and the migration target server;
before the guest operating system is migrated, setting transmission data transmitted to the migration objective guest operating system to be looped back, in the host operating system of the connection target server; and
after the guest operating system is migrated, based on the acquired connection information, setting the virtual network connection to the host operating system that operates in the migration target server, to transmit the transmission data from the migrated guest operating system to the guest operating system that operates in the connection target server, and also, canceling the setting of the transmission data transmitted to the migration objective guest operating system to be looped back, and setting the virtual network connection to the host operating system that operates in the connection target server, to transmit the transmission data to the guest operating system migrated to the migration target server.

2. A computer readable recording medium storing a network setting program causing the computer to execute a process according to claim 1,
wherein a virtual IP address is allocated to the guest operating system in each of the plurality of servers, and based on network setting associated with a physical IP address of a separate server being the connection target, the virtual IP address of the guest operating system of the separate server and tunnel information to be used for the virtual network connection to the separate server, the host operating system in each server specifies the physical IP address of the separate server being transmission target from the virtual IP address of the guest operating system of the separate server, which is attached to the data transmitted from the guest operating system in the own server to the separate server, and thereafter, performs a tunneling on the data in accordance with the tunnel information to transmit the data, and
wherein the process of acquiring the connection information, comprises, referring to a table indicating a relation between each server and the corresponding physical IP address thereof and a table indicating each server and the corresponding virtual IP address of the guest operating system that operates therein, to acquire the physical IP address of the connection target server and the virtual IP address of the guest operating system that operates in the connection target server, and
the process of setting the virtual network connection after the guest operating system is migrated, comprises, setting, to the host operating system that operates in the migration target server, the acquired physical IP address of the connection target server and the acquired virtual IP address of the guest operating system that operates in the connection target server to be associated with the tunnel information used for the virtual network connection established from the migration target server to the connection target server, and also, setting, to the host operating system that operates in the connection target server, the physical IP address of the migration target server and the virtual IP address of the guest operating system migrated to the migration target server to be associated with the tunnel information used for the virtual network connection established from the connection target server to the migration target server.

3. A computer readable recording medium storing a network setting program causing the computer to execute a process according to claim 1,
wherein when the connection target server is a plurality of connection target servers, the processes of acquiring the connection information, setting the transmission data for the migration objective guest operating system to be looped back before the guest operating system is migrated, and setting the virtual network connection after the guest operating system is migrated are executed for all of the plurality of connection target servers.

4. A network setting method executed in a computer, which is connected to a plurality of servers each including a virtual machine environment in which a host operating system that directly performs communications with another server using a virtual network and a guest operating system that is started up to execute a service program for processing a customer's service and performs communications with said another server only via the host operating system, are operable as virtual operating systems, the method comprising:
when a first server of the plurality of servers is designated to be a migration source server and a second server is designated to be a migration target server, and when an operator issues an instruction to migrate a guest operating system that operates in the migration source server to the migration target server, referring to a table in which connection target servers being virtual network connection targets of the respective servers are set, to specify the connection target server of the migration source server;
acquiring connection information necessary for establishing a virtual network connection between the specified connection target server and the migration target server;
before the guest operating system is migrated, setting transmission data transmitted to the migration objective guest operating system to be looped back, in the host operating system of the connection target server; and
after the guest operating system is migrated, based on the acquired connection information, setting the virtual network connection to the host operating system that operates in the migration target server, to transmit the transmission data from the migrated guest operating system to the guest operating system that operates in the connection target server, and also, canceling the setting of the transmission data transmitted to the migration objective guest operating system to be looped back, and setting the virtual network connection to the host operating system that operates in the connection target server, to transmit the transmission data to the guest operating system migrated to the migration target server.

5. A network setting apparatus connected to a plurality of servers each including a virtual machine environment in which a host operating system that directly performs communications with another server using a virtual network and a guest operating system that is started up to execute a service program for processing a customer's service and performs communications with said another server only via the host operating system, are operable as virtual operating systems, the apparatus comprising:
connection target specifying unit for, when a first server of the plurality of servers is designated to be a migration source server and a second server is designated to be a migration target server and when an operator issues an instruction to migrate the guest operating system that operates in the migration source server to the migration target server, referring to a table in which connection target servers being virtual network connection targets of the respective servers are set, to specify the connection target server of the migration source server;
connection information acquiring unit for acquiring connection information necessary for establishing a virtual network connection between the connection target server and the migration target server;
first setting unit for, before the guest operating system is migrated, setting transmission data transmitted to the migration objective guest operating system to be looped back, in the host operating system of the connection target server; and
second setting unit for, after the guest operating system is migrated, based on the connection information, setting the virtual network connection to the host operating system that operates in the migration target server, to transmit the transmission data from the migrated guest operating system to the guest operating system that operates in the connection target server, and also, canceling the setting of the transmission data transmitted to the migration objective guest operating system to be looped back, and setting the virtual network connection to the host operating system that operates in the connection target server, to transmit the transmission data to the guest operating system migrated to the migration target server.
